(19) United States
(12) Patent Application Publication
(10) Pub. No.: US 2008/0143637 A1
(43) Pub. Date: Jun. 19, 2008

(54) Multiscreen display apparatus

(75) Inventors: Yusuke Sunahara, Yokohama (JP); Hiroyuki Urata, Yokohama (JP); Satoshi Shibuya, Yokohama (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 11/802,631

(22) Filed: May 24, 2007

(30) Foreign Application Priority Data
Dec. 13, 2006 (JP) 2006-335251

(51) Int. Cl. G09G 5/00

(52) U.S. Cl. 345/1.1

(57) ABSTRACT

A phase shifter is provided to adjust the phase of the pixel clock generated by a PLL to the data of the digital image signal regenerated by a digital interface receiver circuit. The pixel clock which is output from the phase shifter is used as a pixel clock in a digital interface transmitter circuit.

### CLAIM OF PRIORITY

The present application claims priority from Japanese application serial no. JP 2006-335251, filed on Dec. 13, 2006, the content of which is hereby incorporated by reference into this application.

### BACKGROUND OF THE INVENTION

(1) Field of Invention

The present invention relates to a daisy chain circuit provided in a multiscreen display apparatus which forms single images on a plurality of image display units arranged in a matrix form. In particular, the invention relates to a daisy chain circuit which is provided in each of plural image display units in order to cascade (or daisy-chain) them and distribute a TMDS (Transition Minimized Differential Signaling), LVDS (Low Voltage Differential Signal) or other serial differential signaling format high speed digital image signal to them.

(2) Description of the Related Art

In JP-A-2000-184315 and JP-A-2004-347739, conventional multiscreen display apparatus are disclosed where a single image is formed on a plurality of image display units arranged in a matrix (two-dimensional) form and cascaded (hereafter expressed as daisy-chained) so that each image display unit passes a digital image signal to the subsequent image display unit by TMDS, LVDS or other serial differential signaling format high speed signaling technology.

### SUMMARY OF THE INVENTION

In the daisy-chained digital image signal transmission scheme described in JP-A-2000-184315, however, jitter is introduced to the image clock (or dot clock) when it is reproduced by the internal PLL (Phase Locked Loop) of the digital interface receiver for serial to parallel conversion of the high speed digital image signal and by the internal PLL of the digital interface transmitter for conversion vice versa. Toward the last image display unit in the daisy chain, the jitter amount increases accumulatively. Thus, the number of daisy-chained image display units is limited since the digital interface transmitters of rear image display units in the daisy chain may make errors when acquiring imaged data.

In the case of JP-A-2004-347739, the disclosed daisy chain circuit makes it possible to daisy chain an unlimited number of image display units.

The daisy chain circuit described in JP-A-2004-347739 generates an output pixel clock (RCLK) separate from the input pixel clock (WCLK) and, using this output pixel clock, re-samples the input image data for output. According to this, noise due to the clock, etc. is not propagated to the subsequent image display unit and therefore the number of daisy chained image display units is not limited. Digital image data is once written in memory and read out by a stable clock generated from a quartz or the like and the sync signal is latched and output by the clock. This eliminates the clock signal's jitter caused by the internal PLL of the digital interface. Thus, since each image display unit does not increase the jitter of the clock signal due to daisy chain connection, the digital interface transmitter circuits do not make errors when acquiring the image data even if the number of daisy-chained image display units is increased.

However, a memory to temporally store input digital image data for re-sampling, an oscillating circuit to generate the output pixel clock, a control circuit to control the memory, etc. are needed in the above-mentioned daisy chain circuit. This makes the circuit scale larger and the configuration more complicated.

In addition, latching the input sync signal by the output pixel clock to obtain the output sync signal may pose a problem. As shown in FIG. 13, if the period T1 of the input sync signal 903 is an integer multiple of the period of the output pixel clock 905A, the interval between a fall of the input sync signal 903 and the subsequent rise (latch timing) of the output pixel clock 905A is constant, that is, the latch timing is fixed, resulting in the output sync signal 907A having a constant period T2. However, if the T1 of the input sync signal 903 is not an integer multiple of the period of the output pixel clock 905B, the interval between a fall of the input sync signal 903 and the subsequent rise (latch timing) of the output pixel clock 905B is not constant. In this case, the period (T3, T4, T5) of the output sync signal 907 is not constant. If a sync signal having such an inconstant period is input into such a display as a cold cathode fluorescent tube sensitive to the sync signal, there arises such a problem that the images may have noise.

The present invention was made in view of the above-mentioned situation. It is an object of the present invention to provide high quality images even if the number of connected units is increased.

To solve the above-mentioned problem, a daisy chain circuit is configured so that a pixel clock outputted from the phase shifter is used as a pixel clock for a digital interface transmitter circuit.

According to the present invention, it is possible to provide high quality images even if the number of connected daisy chain circuits is increased.

### BRIEF DESCRIPTION OF THE DRAWINGS

FIG. 1 is a block diagram to explain the configuration of an image display unit indicating a first embodiment of the present invention.

FIG. 2 is a block diagram to explain the configuration of a multiscreen display apparatus according to the first embodiment.

FIG. 3 is a signal waveform diagram to explain the operation of a phase shifter according to the first embodiment.

FIG. 4 is a block diagram to explain the configuration of an image display unit according to a second embodiment of the present invention.

FIG. 5 a block diagram to explain the configuration of a multiscreen display apparatus according to the first embodiment.

FIG. 6 is a block diagram according to a modification of the first embodiment.

FIG. 7 is a block diagram according to a modification of the second embodiment.

FIG. 8 is a block diagram to explain the configuration of an image display unit according to a third embodiment of the present invention.

FIG. 9 is a block diagram to explain the configuration of a multiscreen display apparatus according to the third embodiment.

FIG. 10 is a block according to a modification of third embodiment.

FIG. 11 is a block diagram to explain the configuration of a multiscreen display apparatus according to a fourth embodiment.

FIG. 12 is a diagram to explain how the magnitude of jitter of the output pixel clock changes in the multiscreen display apparatus according to the fourth embodiment.

FIG. 13 is a diagram to explain why jitter is caused to an output sync signal obtained by latching an input sync signal by a clock.

### DETAILED DESCRIPTION OF THE PREFERRED EMBODIMENT

With reference to the drawings, the following will provide a detailed description of the best mode for carrying out the present invention. Note that in all of the drawings provided to explain embodiments of the present invention, elements having the same function are given the same reference numeral and redundant description thereof is avoided. Also note that although it is assumed below for the convenience of description that the TMDS signaling format is used as the serial differential signaling format for daisy chain connection, it is not necessary to exclusively use this format.

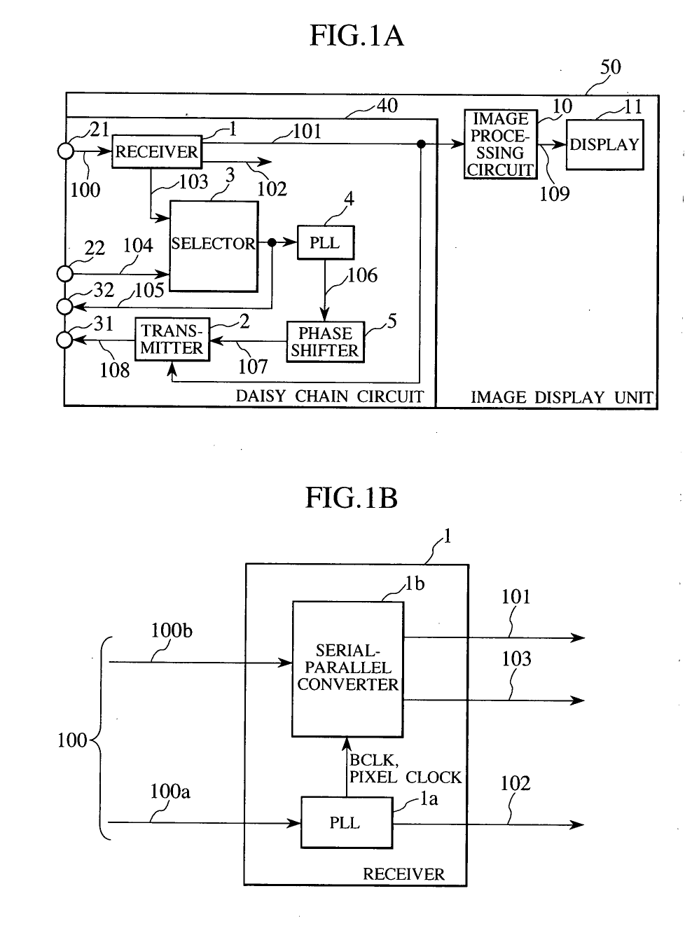

FIG. 1A is a schematic block diagram of an image display unit which is a component of a multiscreen display apparatus and indicates a first embodiment of the present invention. As well, FIG. 1B is a schematic block diagram of a receiver included in a daisy chain circuit in the image display unit.

In FIG. 1A, the image display unit 50 in the multiscreen display apparatus has an end provided with: an image signal input terminal 21 to which a TMDS serial high speed signaling format digital image signal 100 is input; a reference signal input terminal 22 to which a reference signal (hereinafter denoted as “reference input signal”) 104 is input from the outside; an image signal output terminal 31 which outputs a serial high speed signaling format digital image signal 108; and a reference signal output terminal 32 which outputs a reference signal (hereinafter denoted as “reference output signal”) 105 to the outside.

Note that if the high speed digital image signal 100 employs the TMDS signaling format, at least a channel for transmitting image data (what is called the pixel data) and coded horizontal sync signal data and a channel for transmitting a clock (what is called the pixel clock) must be provided.

The reference signal input terminal 22 is a terminal to input a reference output signal output from the reference signal output terminal 32 of the preceding daisy-chained image display unit as the reference signal (reference input signal). In the present embodiment, the reference output signal is the reference sync signal (detailed later). To the reference signal input terminal 22, a reference sync signal is input from the outside (reference signal output terminal of the preceding image display unit) as the reference signal (reference input signal). Hereinafter, this input reference sync signal is denoted as the external reference sync signal by adding “external” to discriminate it from the output reference sync signal. The reference signal input terminal 22 will be described again later in detail.

The image display unit 50 incorporates a daisy chain circuit 40, an image processing circuit 10 and a display 11.

The daisy chain circuit 40 performs reception and transmission of digital image information (pixel data, pixel clock, etc.) by TMDS serial high speed signaling transmission to and from a plurality of image display units which are daisy chained to constitute the multiscreen display apparatus. In addition, from the received serial image information, it regenerates the pixel clock 102, horizontal sync signal 103, parallel digital image signal 101 and others.

The image processing circuit 10 outputs an image signal 109 which is obtained by performing scan convert, zoom up/down and other certain image processing operations on the parallel digital image signal 101 from the daisy chain circuit 40 according to what is to be displayed by the image display unit 50. The display 11 is display means for displaying the image signal 109 from the image processing circuit 10.

The following provides a detailed description of the configuration of the daisy chain circuit 40.

The daisy chain circuit 40 comprises a digital interface receiver (hereinafter abbreviated as “receiver”) 1, a digital interface transmitter (hereinafter abbreviated as “transmitter”) 2, a selector 3, a PLL 4 and a phase shifter 5.

The receiver 1 to receive the serial high speed digital image signal 100 entered from the image signal input terminal 21 comprises a PLL 1a and a serial-parallel converter 1b as shown in FIG. 1B. Based on the pixel clock 100a contained in the high speed digital image signal 100, the PLL 1a regenerates the pixel clock 102 having the same frequency and generates a bit clock (BCLK) and timing signal (not shown in the figure) for serial to parallel data conversion.

The serial-parallel converter 1b acquires serial data 100b contained in the high speed digital image signal 100 in synchronization with the BCLK and converts the serial data to parallel in sync with the pixel clock 102 for outputting a parallel digital image signal 101 and horizontal sync signal 103. Thus, the receiver 1 regenerates the pixel clock 102 from the high speed digital image signal 100 and outputs the digital image signal 101 and the horizontal sync signal 103.

The selector 3 selects the horizontal sync signal 103 regenerated by the receiver 1 or the reference input signal 104 entered from the reference signal input terminal 22. The reference input signal 104 is an external reference sync signal (external horizontal sync signal) supplied from the preceding daisy-chained image display unit as described later. The horizontal sync signal selected by the selector 3 is not only supplied to the PLL 4 but also output from the reference signal output terminal 32 as the reference output signal 105.

To simplify the following description, let us denote the reference output signal 105 as the reference sync signal 105 unless unclear. The selector 3 may be implemented in such a manner that its selection is switched by operation control means (hereinafter denoted as a “CPU: Central Processing Unit”) which is incorporated in some image display unit (not shown in the figure) to control all image display units 50 according to a command from, for example, a user-operated remote controller or an external control device (such as a PC) although either is not shown in the figure.

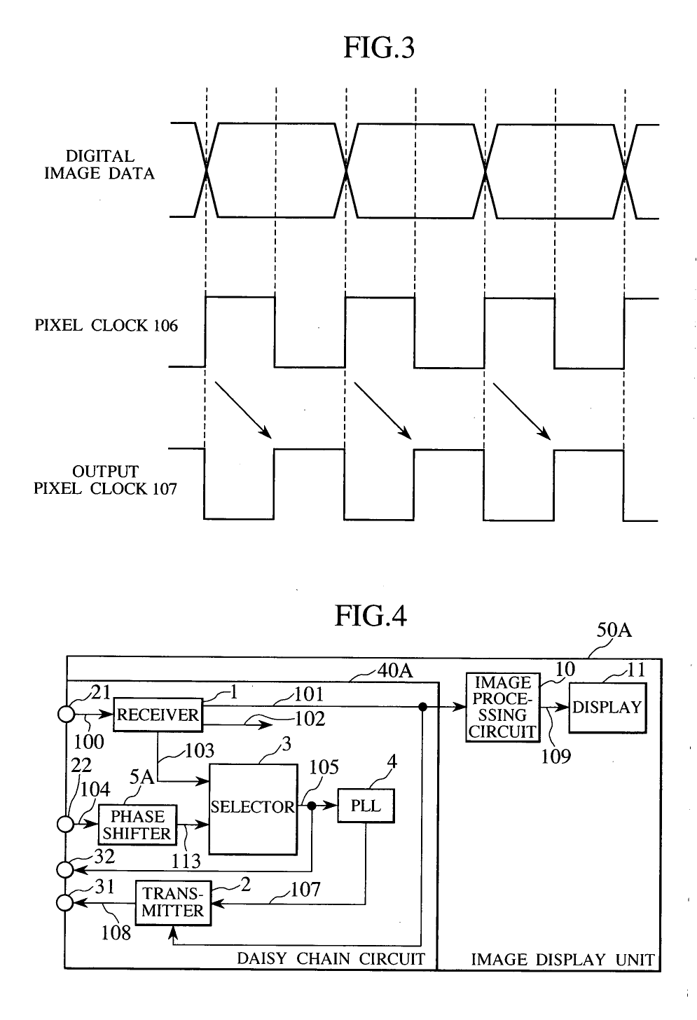

Based on the reference sync signal 105 selected by the selector 3, the PLL 4 generates the pixel clock 106 according to the resolution of the entered high speed digital image signal 100. The pixel clock 106 has the same frequency as the pixel clock 102. The phase shifter 5 adjusts the phase of the pixel clock 106 generated by the PLL 4 with reference to the digital image signal 101 regenerated by the receiver 1 (as described later in detail with FIG. 3) and outputs the adjusted output pixel clock 107.

The transmitter 2 receives the digital image signal 101 from the receiver 1 and the output pixel clock 107 from the phase shifter 5. Based on the output pixel clock 107, an internal PLL not shown in the figure generates a bit clock (not shown in the figure) needed for parallel to serial data conversion. By using this bit clock, the digital image signal 101 is converted to the high speed digital image signal 108 for output to the image signal output terminal 31.

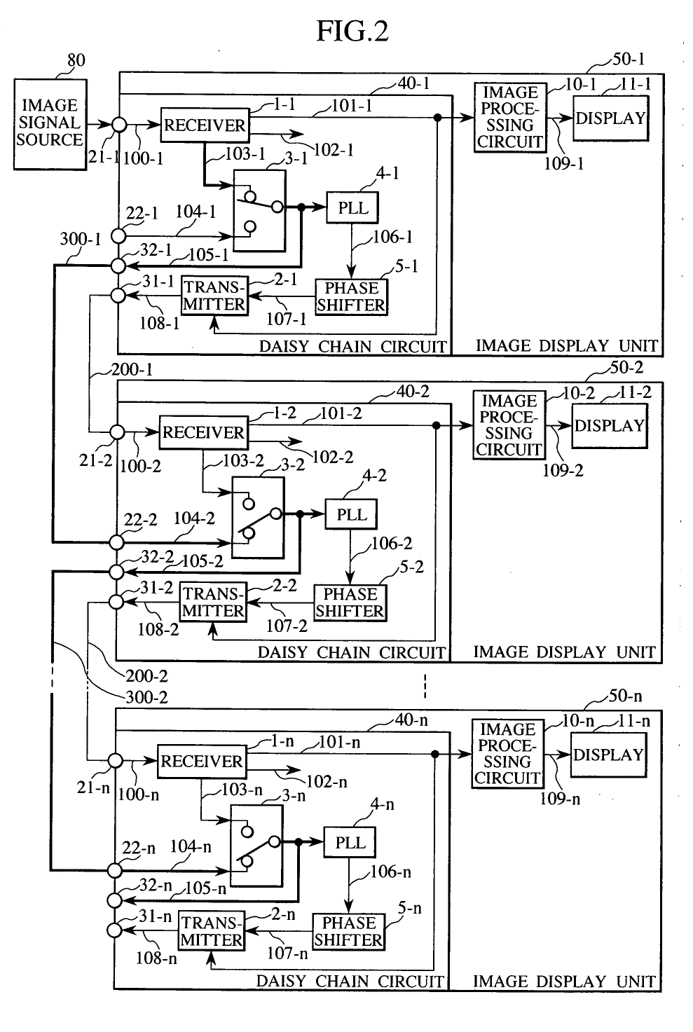

FIG. 2 shows an example of a n-screen display apparatus configured by daisy chaining n image display units of FIG. 1 (n: integer). In FIG. 2, each reference numeral is given a suffix -1, -2, . . . or -n to discriminate the individual image display units and their constituent elements from each other unless not necessary.

As shown in FIG. 2, the multi-screen display apparatus of the present embodiment comprises a plurality of image display units 50-1 through 50-n which are sequentially cascaded (daisy chained) by connecting the output terminals (image signal output terminal 31 and reference signal output terminal 32) of each image display unit to the input terminals (image signal input terminal 21 and reference signal input terminal 22) of the subsequent image display unit by using a digital image signal transmission cable 200 and reference signal transmission cable 300.

In the case of the first image display unit 50-1, a high speed digital image signal 100-1 is supplied to its image signal input terminal 21-1 from an image signal source 80. No signal is supplied to its reference signal input terminal 22-1.

Then, operation of the present embodiment is described below.

Firstly, the following describes the transmitting operation of the reference sync signal.

In the first image display unit 50-1, the receiver 1-1 regenerates a horizontal sync signal 103-1 from the high speed digital image signal 100-1 supplied from the image signal source 80. Then, the selector 3-1 selects the horizontal sync signal 103-1 as the reference sync signal 105-1 and outputs the reference sync signal 105-1 to the next image display unit 50-2 from the reference signal output terminal 32-1.

To be exact, the horizontal sync signal 103-1 regenerated by the receiver 1-1 has a small amount of jitter since it is regenerated based on the bit clock (BCLK) and pixel clock 102-1 regenerated by the internal PLL 1a-1 of the receiver 1-1. However, the jitter caused in this stage may be regarded as negligibly small. That is, the reference sync signal 105-1 can be regarded as jitter-free.

In each of the subsequent image display units 50 (50-2, 50-3, . . . ), the reference input signal 104 from the reference input terminal 22, which is an external reference sync signal supplied from the precedent image display unit, is selected by the selector 3 as the reference sync signal 105 to output the reference sync signal 105 from the reference signal output terminal 32 to the next image display unit.

Thus, the reference sync signal 105 supplied to the PLL 4 in any of the daisy-chained image display units 50 can be made equal to the horizontal sync signal 103-1 of the first image display unit 50-1. That is, due to this daisy-chain transmission of the horizontal sync signal 103-1 regenerated by the first stage, the jitter of the reference sync signal 105 supplied to the PLL 4 in any of the image display units 50 can be suppressed to substantially the same level as of the first reference sync signal 105-1 (namely the horizontal sync signal 103-1). It is therefore possible in every image display unit 50 to reduce the jitter of the pixel clock 106 generated by the PLL 4 based on the reference sync signal 105.

Then, the following describes the transmitting operation of the image signal. In the first image display unit 50-1, the high speed digital image signal 100-1 from the image signal source 80 is converted to a digital image signal 101-1 by the receiver 1-1. The digital image signal 101-1 is entered into the image processing circuit 10-1 and the transmitter 2-1. The image processing unit 10-1 performs certain image processing (scan convert, zoom up/down or the like) on the digital image signal 101-1 and displays the result on the display 11-1 as an image. The transmitter 2-1 converts the digital image signal 101-1 to a high speed digital image signal 108-1 by using the output pixel clock 107-1 which is generated by the PLL 4-1 and phase-adjusted by the phase shifter 5-1 based on the reference sync signal 105-1. The high speed digital image signal 108-1 is transmitted to the next image display unit 50-2. Each of the image display unit 50-2 and the subsequent image display units transmits the image signal in the same manner, resulting in the image signal passed to all of the daisy-chained image display units.

In the meantime, the digital image signal 101 is regenerated by the receiver 1 from the digital image information multiplexed into the high speed digital image signal 100. Therefore, due to their transmission routes differing in cable capacitance, circuit delay and the like, the digital image signal 101 generally lags in phase behind the pixel clock 106 which is generated by the PLL 4 based on the reference sync signal 105. This delay may cause the transmitter 2 to commit data errors when the transmitter 2 converts the parallel digital image signal 101 to the high speed digital image signal 108. This is because the phase shifter 5 is inserted between the PLL 4 and the transmitter 2 to compensate for the phase difference between the pixel clock 106 and the digital image signal 101.

The following concretely describes the operation of the phase shifter 5 by using FIG. 3.

FIG. 3 is a signal waveform diagram to explain the operation of the phase shifter. As shown in FIG. 3, the transmitter 2 makes an error when acquiring the digital image data if the rising edge of the pixel clock 106 comes near to a transition of the digital image data of the digital image signal 101. Therefore, the phase shifter 5 delays the phase of the pixel clock 106 by a certain amount to locate the rising edges to around the center of the image data of the digital image signal 101 from the receiver 1 so that the transmitter 2 can correctly read the digital image data.

As mentioned so far, in each of the daisy chained image display units 50 in the multiscreen display apparatus of the present embodiment, the output pixel clock 107 entered into the transmitter 102 is generated by the PLL 4 based on the reference sync signal 105 which is obtained by daisy chain transmission of the horizontal sync signal 103-1 regenerated in the first stage. Therefore, the amount of jitter of the output pixel clock 107 in each image display unit 50 is small and substantially constant. Likewise, the amount of jitter of the high speed digital image signal 108 generated by using the output pixel clock 107 is small and substantially constant in each display unit 50.

Consequently, since the transmitter 2 in each image display unit does not make errors when acquiring the digital image data, it is possible to display noise-free images even if a limitless number of image display units are daisy-chained.

In addition, according to the present embodiment, since the output pixel clock 107 is generated based on the reference sync signal 105 obtained by daisy chain transmission of the horizontal sync signal 103-1, an integer multiple of the period of the output pixel clock 107 is equal to the period of the horizontal sync signal 103. Therefore, not like the multiscreen display apparatus described in JP-A-2004-347739, there is no possibility that the period of the sync signal may fluctuate.

Further, the daisy chain circuit in the multiscreen display apparatus of the present embodiment can be realized by a simple circuit configuration in which only the selector 3, PLL 4 and phase shifter 5 are added to the receiver 1 and transmitter 2. The receiver 1 and transmitter 2 constitute the conventional daisy chain circuit.

FIG. 4 is a schematic block diagram of the configuration of each of image display units constituting a multiscreen display apparatus according to a second embodiment of the present invention.

The second embodiment is different from the first embodiment in that the phase shifter to correct the phase of the pixel clock 106 generated by the PLL 4 is inserted between the reference signal 22 and the selector 3.

As shown in FIG. 4, an image display unit 50A in the second embodiment includes a daisy chain circuit 40A, an image processing circuit 10 and a display 11.

The daisy chain circuit 40A includes a receiver 1, a transmitter 2, a phase shifter 5A, a selector 3 and a PLL 4.

The receiver 1 receives the serial high speed digital image signal 100 entered from the image signal input terminal 21. In the high speed digital image signal 100, the pixel clock 100a is included. Based on the pixel clock 100a, the receiver 1 uses the internal PLL 1a to generate a bit clock (BCLK) needed for serial to parallel data conversion. Using the bit clock, the receiver 1 regenerates the horizontal sync signal 103, parallel digital image signal 101, etc. The digital image signal 101 is supplied to the transmitter 2 and image processing circuit 10. The image processing circuit 10 performs certain image processing on the entered digital image signal 101 for output to the display 11.

The phase shifter 5A adjusts the phase of the reference input signal 104 entered from the reference signal input terminal 22 and outputs the adjusted reference signal 113. Here, the reference input signal 104 is an external reference sync signal (external horizontal sync signal).

The selector 3 selects the adjusted reference signal 113 from the phase shifter 5A or the horizontal sync signal 103 regenerated by the receiver 1. The horizontal sync signal selected by the selector 3 is not only supplied to the PLL 4 but also output from the reference signal output terminal 32 as the reference output signal 105.

Based on the reference sync signal 105 selected by the selector 3, the PLL 4 generates the output pixel clock 107 according to the resolution of the entered high speed digital image signal 100.

The transmitter 2 receives the digital image signal 101 from the receiver 1 and the output pixel clock 107 from the PLL 4. Based on the output pixel clock 107, an internal PLL not shown in the figure generates a bit clock (not shown in the figure) needed for parallel to serial data conversion. By using this bit clock, the digital image signal 101 is converted to the high speed digital image signal 108 for output to the image signal output terminal 31.

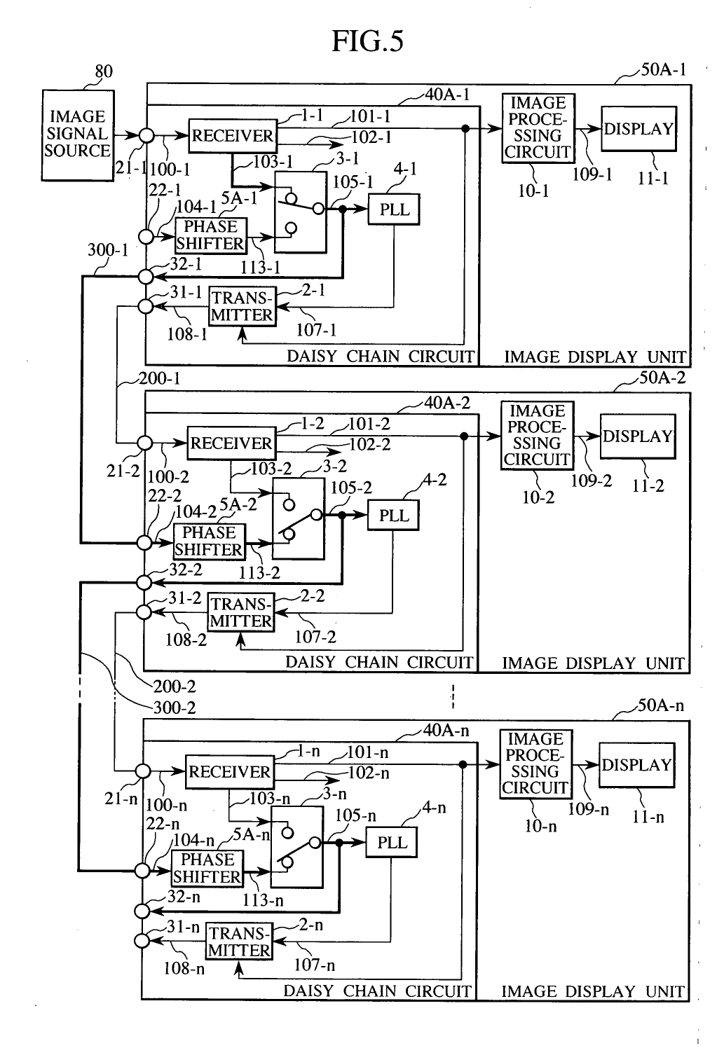

FIG. 5 shows an example of a configuration in which the image display unit of FIG. 4 is applied to the multiscreen display apparatus of FIG. 2. In terms of connections for each signal, the multi-screen display apparatus of FIG. 5 is similar to the first embodiment of FIG. 2. That is, the image display units are sequentially cascaded (daisy chained) by connecting the output terminals (image signal output terminal 31 and reference signal output terminal 32) of each image display unit to the input terminals (image signal input terminal 21 and reference signal input terminal 22) of the subsequent image display unit by using a digital image signal transmission cable 200 and reference signal transmission cable 300.

Then, operation of the present embodiment is described below.

Firstly, the following describes the transmitting operation of the reference sync signal.

In the first image display unit 50A-1, the receiver 1-1 regenerates a horizontal sync signal 103-1 from the high speed digital image signal 100-1 supplied from the image signal source 80. Then, the selector 3-1 selects the horizontal sync signal 103-1 as the reference sync signal 105-1 and outputs the reference sync signal 105-1 to the next image display unit 50A-2 from the reference signal output terminal 32-1.

In each of the subsequent image display units 50A (50A-2, 50A-3, . . . ), the reference input signal 104 from the reference input terminal 22 is adjusted in phase by the phase shifter 5 to obtain the adjusted reference signal 113. Then, the adjusted reference signal 104 is selected by the selector 3 as the reference sync signal 105. The selector 3 outputs the reference sync signal 105 from the reference signal output terminal 32 to the next image display unit and supplies it to the PLL 4.

The PLL 4 generates the output pixel clock 107 and supplies it to the transmitter 2. Due to the compensation done by the phase shifter 5A, this output pixel clock 107 has each rising edge located around at the center of the image data of the regenerated digital image signal 101. This allows the transmitter 2 to correctly read the image data of the digital image signal 101.

Thus, the reference sync signal 105 supplied to the PLL 4 in any of the daisy-chained image display units 50A can be made equal to the horizontal sync signal 103-1 of the first image display unit 50-1. That is, due to this daisy-chain transmission of the horizontal sync signal 103-1 regenerated by the first stage, the jitter of the reference sync signal 105 supplied to the PLL 4 in any of the image display units 50 can be suppressed to substantially the same level as of the first reference sync signal 105-1 (namely the horizontal sync signal 103-1). It is therefore possible in every image display unit 50A to reduce the jitter of the pixel clock 107 generated by the PLL 4 based on the reference sync signal 105.

Then, the following describes the transmitting operation of the image signal. In the second embodiment, the output pixel clock 107 generated by the PLL 4 based on the reference sync signal 105 is used by the transmitter 2 to convert the digital image signal 101 to the high speed digital image signal 108. Detailed description of the transmitting operation is omitted here since there is no other difference between the first embodiment and the second embodiment.

Similar to the first embodiment, as mentioned so far, in each of the daisy chained image display units 50A in the multiscreen display apparatus of the present embodiment, the output pixel clock 107 entered into the transmitter 102 is generated by the PLL 4 based on the same reference sync signal 105 which is obtained by daisy chain transmission of the horizontal sync signal 103-1 regenerated in the first stage. Therefore, the amount of jitter of the output pixel clock 107 in each image display unit 50A is small and substantially constant. Likewise, the amount of jitter of the high speed digital image signal 108 generated by using the output pixel clock 107 is small and substantially constant in each display unit 50. Consequently, since the transmitter 2 in each image display unit does not make errors when acquiring the digital image data, it is possible to display noise-free images even if a limitless number of image display units are daisy-chained.

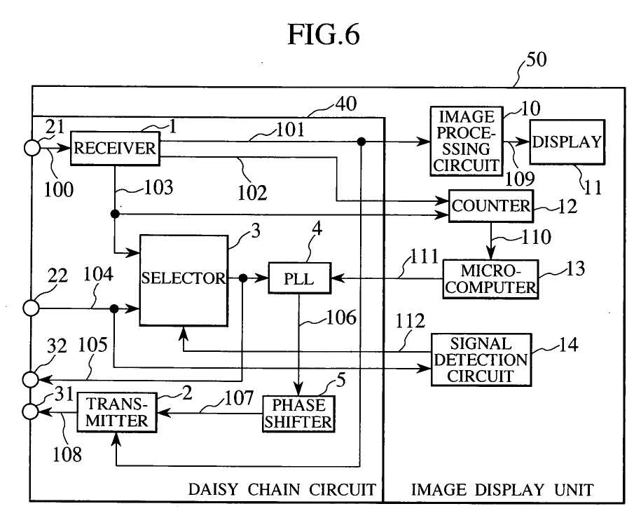

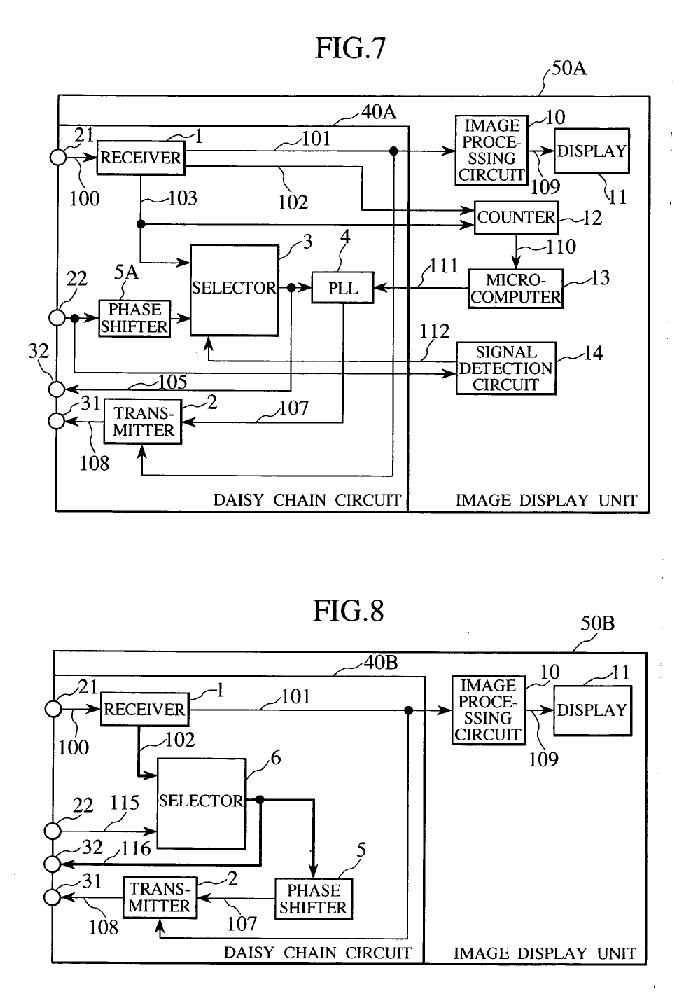

The following describes variations of the first and second embodiments. FIG. 6 shows a variation of the first embodiment while FIG. 7 shows a variation of the second embodiment.

In either variation, a signal detection circuit 14 to detect whether the reference input signal from the reference signal input terminal 22 is present, a counter 12 to measure the number of horizontal pixels from the horizontal sync signal 103 and pixel clock 102 which are regenerated by the receiver 1 and a microcomputer 13 which is a processor to set a dividing ratio of the PLL 4 are added to the first or second embodiment as shown in FIGS. 6 and 7.

The signal detection circuit 14 detects whether the reference input signal 104 is present. If detected, the signal detection circuit 14 outputs a selector control signal 112 to turn the selector 3 to the reference input signal 104 side (or adjusted reference signal 113 side). If not detected, the selector 3 is turned to the horizontal sync signal 103 side. The microcomputer 13, based on the counter measurement signal 110 indicating the number of horizontal pixels measured by the counter 12, calculates a dividing ratio (to be set) of the PLL 4 and supplies a PLL control signal 111 to the PLL 4 to set the calculated dividing ratio of the PLL 4.

The above-mentioned circuit configuration allows the image display unit to internally control the selector 3 and PLL 4 by itself, eliminating the necessity of external control by an external control PC, remote control operation or the like.

FIG. 8 is a schematic block diagram of the configuration of each of image display units constituting a multiscreen display apparatus according to a third embodiment of the present invention.

The third embodiment is different from the first embodiment in that the pixel clock 102 or the external pixel clock entered externally as the reference input signal is selected by the selector 6 and the output pixel clock is obtained by correcting the phase or delay of the selected pixel clock. Therefore, no PLL is used to generate the output pixel clock. In other terms, the present embodiment is identical to the first embodiment. Each element having the same function as the corresponding one is given the same reference numeral and its redundant description thereof is omitted.

The daisy chain circuit 40B in the image display unit 50B of the present embodiment includes a receiver 1, a transmitter 2, a selector 6 and a phase shifter 5.

The receiver 1 receives the serial high speed digital image signal 100 entered from the image signal input terminal 21 and, based on the pixel clock 100a included in the high speed digital image signal 100, uses its internal PLL 1a to generate a bit clock (BCLK) needed for serial to parallel data conversion. Using the bit clock, the receiver 1 also regenerates the horizontal sync signal 103, parallel digital image signal 101, etc. The digital image signal 101 is supplied to the transmitter 2 and image processing circuit 10. The image processing circuit 10 performs certain image processing on the entered digital image signal 101 for output to the display 11.

The selector 6 selects the external pixel clock 115 entered from the reference signal input terminal 22 as the reference input signal or the pixel clock 102 regenerated by the receiver 1. The pixel clock selected by the selector 6 is not only supplied to the phase shifter 5 but also output from the reference signal output terminal 32 as the reference pixel clock 116 (reference output signal).

The phase shifter 5 adjusts the phase of the reference pixel clock 116 selected by the selector 6 according to the digital image signal 101 regenerated by the receiver 1 and outputs the adjusted clock as the output pixel clock 107.

The transmitter 2 receives the digital image signal 101 from the receiver 1 and the output pixel clock 107 from the phase shifter 5. Based on the output pixel clock 107, an internal PLL not shown in the figure generates a bit clock (not shown in the figure) needed for parallel to serial data conversion. By using this bit clock, the digital image signal 101 is converted to the high speed digital image signal 108 for output to the image signal output terminal 31.

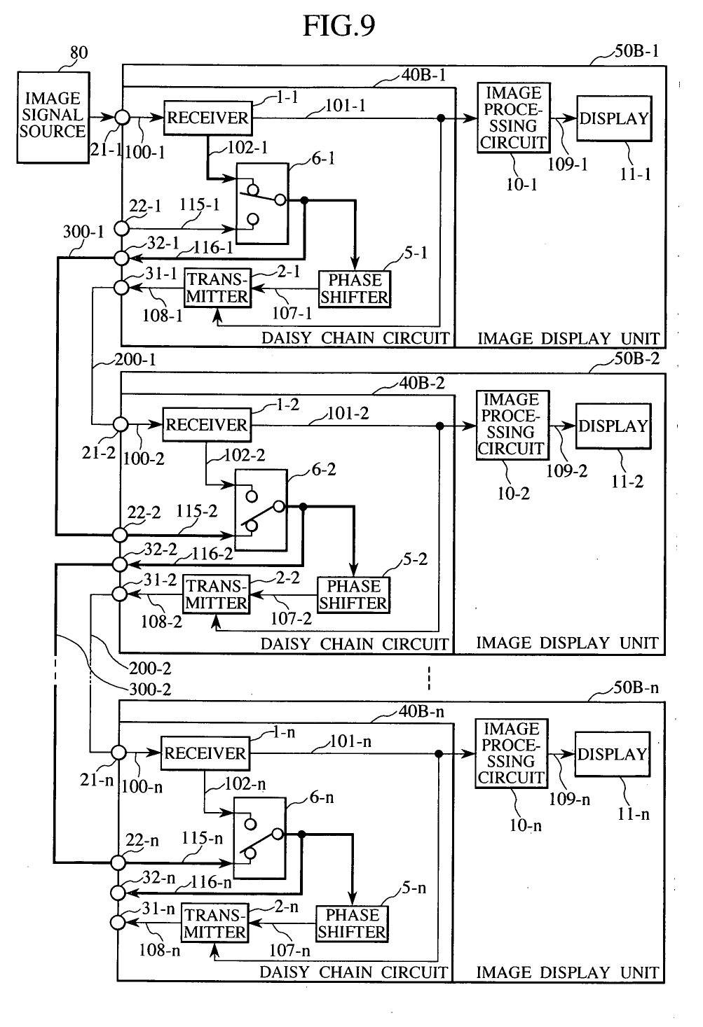

FIG. 9 shows an example of a configuration in which the imaged display unit of FIG. 8 is applied to the multiscreen display apparatus of FIG. 2. In terms of connections for each signal, the multi-screen display apparatus of FIG. 9 is similar to the first embodiment of FIG. 2. That is, the image display units are sequentially cascaded (daisy chained) by connecting the output terminals (image signal output terminal 31 and reference signal output terminal 32) of each image display unit to the input terminals (image signal input terminal 21 and reference signal input terminal 22) of the subsequent image display unit by using a digital image signal transmission cable 200 and reference signal transmission cable 300.

Then, operation of the present embodiment is described below.

Firstly, the following describes the transmitting operation of the reference pixel clock.

In the first image display unit 50B-1, the receiver 1-1 regenerates the pixel clock 102-1 from the high speed digital image signal 100-1 supplied from the image signal source 80. Then, the selector 6-1 selects the pixel clock 102-1 as the reference pixel clock 116-1 and outputs the reference pixel clock 116-1 to the next image display unit 50B-2 from the reference signal output terminal 32-1.

In each of the subsequent image display units 50B (50B-2, 50B-3, . . . ), the external pixel clock 115 from the reference input terminal 22 is selected as the reference pixel clock 116-1 by the selector 6. The selector 6 outputs the reference pixel clock 116 from the reference signal output terminal 32 to the next image display unit and supplies it to the phase shifter 5.

The phase shifter 5 adjusts the phase of the external pixel clock 116 according to the digital image signal 101 regenerated by the receiver 1 and outputs the output pixel clock 107 to the transmitter 2. Due to the compensation done by the phase shifter 5A, this output pixel clock 107 has each rising edge located around at the center of the image data of the regenerated digital image signal 101. This allows the transmitter 2 to correctly read the image data of the digital image signal 101.

Thus, the reference pixel clock 116 supplied to the transmitter 2 in any of the daisy-chained image display units 50B can be made equal to the pixel clock 102-1 of the first image display unit 50B-1. That is, due to this daisy-chain transmission of the reference pixel clock 102-1 regenerated by the first stage, the jitter of the reference pixel clock 116 supplied to the transmitter 2 via the phase shifter 5 in any of the image display units 50B can be suppressed to substantially the same level as of the first reference pixel clock 116-1 (namely the pixel clock 102-1). It is therefore possible in every image display unit 50B to reduce the jitter of the output pixel clock 107.

Then, the following describes the transmitting operation of the image signal. In the third embodiment, the output pixel clock 107 selected by the selector 6 and phase-adjusted by the phase shifter 5 is used by the transmitter to convert the digital image signal 101 to the high speed digital image signal 108. Detailed description of the transmitting operation is omitted here since there is no other difference between the first embodiment and the present embodiment.

Similar to the first embodiment, as mentioned so far, in each of the daisy chained image display units 50B in the multiscreen display apparatus of the present embodiment, the output pixel clock 107 entered into the transmitter 102 is the same reference pixel clock 116 which is obtained by daisy chain transmission of the pixel clock 102-1 regenerated in the first stage. Therefore, the amount of jitter of the output pixel clock 107 in each image display unit 50B is small and substantially constant. Likewise, the amount of jitter of the high speed digital image signal 108 generated by using the output pixel clock 107 is small and substantially constant in each display unit 50. Consequently, since the transmitter 2 in each image display unit does not make errors when acquiring the digital image data, it is possible to display noise-free images even if a limitless number of image display units are daisy-chained.

Since the pixel clock used as the reference signal in the above-mentioned multiscreen display apparatus of the present embodiment has a high frequency, its waveform is likely to deform during transmission over cable. It is therefore difficult to transmit the pixel clock if the resolution of the image signal is high since a high resolution image signal uses a higher frequency pixel clock. However, if the resolution is low or the pixel clock's frequency is low, it is possible to transmit the pixel clock. Accordingly, the multiscreen display apparatus of the present embodiment is effective as a specific apparatus for displaying low resolution image signals since its circuit configuration can be implemented more simply at lower cost than the first and second embodiments.

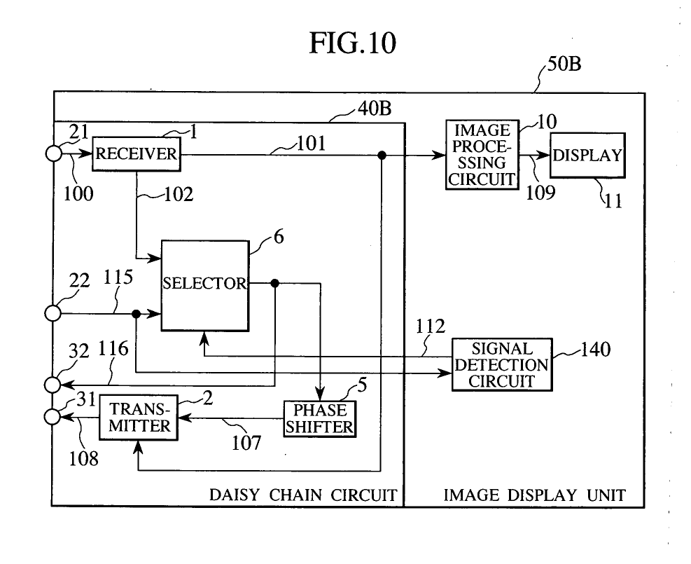

The following describes a variation of the third embodiment. FIG. 10 shows a variation of the third embodiment.

In the variation, as shown in FIG. 10, a signal detection circuit 140 which detects whether the external pixel clock 115 (reference input signal) from the reference signal input terminal 22 is present is added to the third embodiment.

The signal detection circuit 140 detects whether the external pixel clock 115 (reference input signal) is present. If detected, the signal detection circuit 140 outputs a selector control signal 112 to turn the selector 6 to the reference input signal side (here, external pixel clock 115 side). If not detected, the selector 6 is turned to the internal pixel clock 102 side.

The above-mentioned circuit configuration allows the image display unit to internally control the selector 6 by itself, eliminating the necessity of external control by an external control PC, remote control operation or the like.

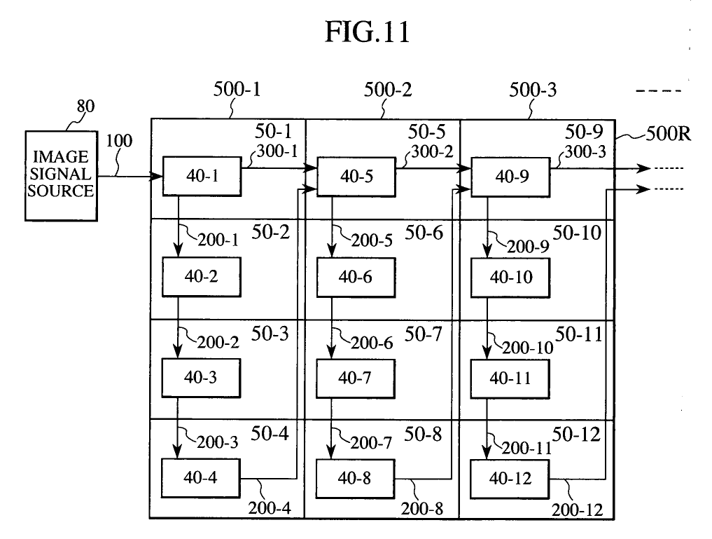

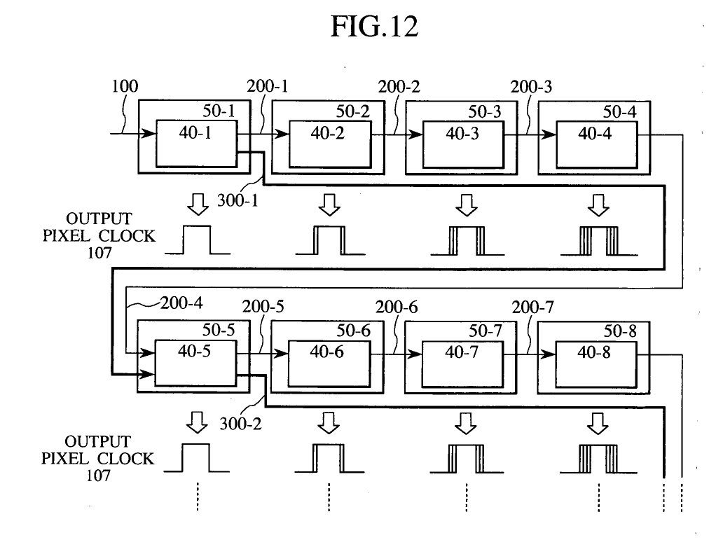

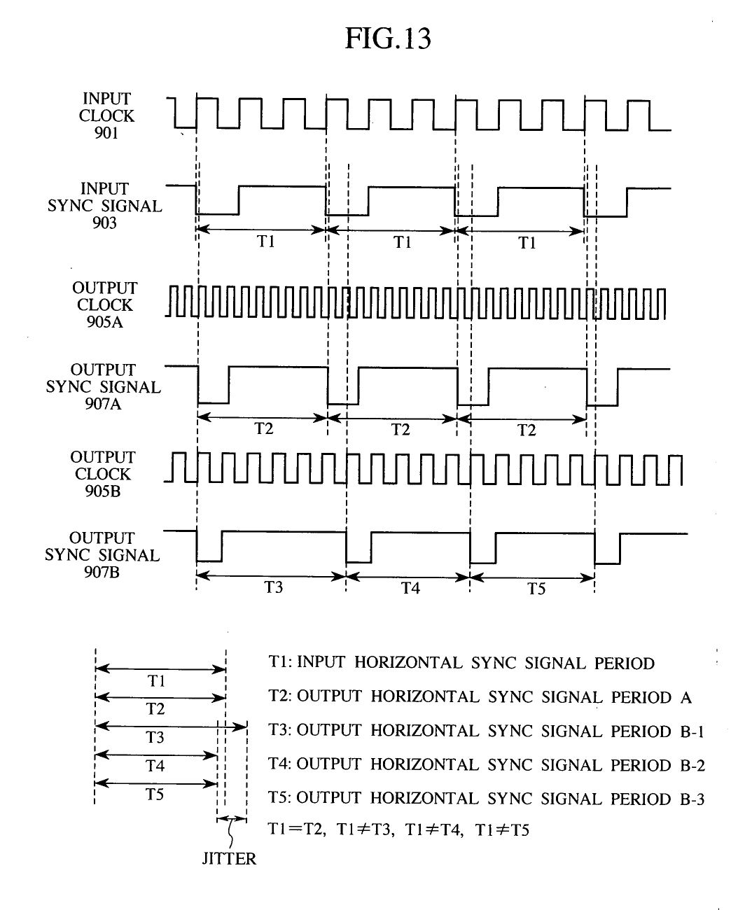

FIG. 11 shows the configuration of a multiscreen display apparatus according to a fourth embodiment of the present invention.

As shown in FIG. 11, the multiscreen display apparatus of the present embodiment comprises image display units 50-1˜50-n of the first embodiment described with FIG. 1.

For transmission of the high speed digital image signal 100, the individual image display units 50-1˜50-n are daisy chained by connecting the image signal output terminal 31 of each image display unit to the image signal input terminal 21 of the next image display unit by using a digital image signal transmission cable 200.

For transmission of the reference sync signal 105, the individual display units 50-1˜50-n are organized into a plurality of blocks each having a certain number of image display units (four in this case). Specifically, image display units 50-1 through 5-4 constitute block 500-1, image display units 50-5 through 50-8 constitute block 500-2, image display units 50-9 through 50-12 constitute block 500-3 and so on.

In any of the image display units constituting each block excluding its first image display unit (50-5, 50-9, . . . ) in the block, the selector 3 selects the horizontal sync signal 103. In the image display unit 50-1, the selector 3 selects the horizontal sync signal 103.

In any of the image display units, except the image display unit 50-1, which are located first in the respective blocks, namely image display units 50-1, 50-5, 50-9, . . . which constitutes a group 500R, the selector 3 selects the reference input signal 104 (external reference sync signal). In addition, as far as the reference sync signal 105 concerns, the image display units constituting the group 500R are daisy-chained by connecting the reference signal output terminal 32 of the first image display unit 50-1 to the reference signal input terminal 22 of the image display unit 50-5, the reference signal output terminal 32 of the image display unit 5-5 to the reference signal input terminal 22 of the image display unit 5-9, and so on by using reference signal transmission cables 300.

Then, the following describes the operation of the present embodiment.

Transmitting operation of the reference sync signal is described below. Since transmitting operation of the image signal is same as in the first embodiment, description thereof is omitted.

In the first image display unit 50-1, the horizontal sync signal 103 is regenerated by the receiver 1 from the high speed digital image signal 100-1 entered from the image signal source 80 and the horizontal sync signal 103 is selected as the reference sync signal 105 by the selector 3. Then, the reference sync signal 105 is output from the reference signal output terminal 32 to the image display unit 50-5 which is four stages downstream.

In each of the image display unit 50-5 and subsequent image display units which belong to the group 500R and receives the reference input signal 104, the reference input signal 104 from the reference signal input terminal 22 is selected by the selector 3 as the reference sync signal 105 and output to the image display unit which is four stages downstream.

In any of the image display units which belongs to each block (500-1, 500-2, . . . ) excluding its first image display unit in the block, the receiver 1 regenerates the horizontal sync signal 103 from the high speed digital image signal 100 entered from the precedent image display unit and the selector 3 selects the horizontal sync signal 103 as the reference sync signal 105.

In the multiscreen display apparatus of the present embodiment, the image display units (50-2, 50-3 and 50-4 in block 500-1, 50-6, 50-7 and 50-8 in block 500-2, etc.) which do not receive the reference input signal 104 are daisy-chained simply in conventional fashion. Therefore, the amount of jitter of the output pixel clock 107 increases. However, the amount of jitter is not so large as to cause the transmitter 2 to make an error since the number of units which are daisy-chained in conventional fashion or the number of image display units per block is as small as three. Conversely, the number of cascaded units per block 500 is determined so as not to cause error.

For the image display units (50-5, 50-9, etc.) which belong to the group 500R and receive the reference input signal 104, the same effect can be achieved as in the first embodiment. That is, the amount of jitter of the output pixel clock 107 and the amount of jitter of the high speed digital image signal 108 generated by using the output pixel 107 are small and substantially constant. Therefore, the amount of jitter of the high speed digital image signal 108 is suppressed by each image display unit of the group 500R which receives the reference input signal 104. Consequently, since the transmitter 2 in each image display unit does not make errors when acquiring the digital image data, it is possible to display noise-free images even if a limitless number of image display units are daisy-chained.

As mentioned so far, the present multiscreen display apparatus has a merit that substantially the same effect as of the first embodiment can be achieved by using a fewer reference signal transmission cables. In the present embodiment, the number of reference signal transmission cables 300 is reduced to a fourth as compared with the first embodiment.

While one reference signal transmission cable 300 is used for every four image display units 50 in the above description, the number (k: integer) of image display units 50 per reference signal transmission cable 300 may be changed appropriately. However, if the image display units 50 which each input the reference input signal 104 are disposed at large intervals, the transmitter 2 may make an error when acquiring the digital image data since the amount of jitter of the output pixel clock 107 increases as in the conventional daisy chain scheme. If an acquisition error occurs when m or more image display units are connected in the conventional daisy chain scheme (m: integer), it is clear that the interval k at which the reference signal transmission cable 300 is connected must satisfy k≦m.

In addition, while it is assumed in the above description that image display units of the first embodiment are used to constitute the present multiscreen display apparatus, it is also possible to achieve substantially the effect by applying image display units of any other embodiment.

What is claimed is:

1. A multiscreen display apparatus comprising a plurality of image display units each having a daisy chain circuit, each of the daisy chain circuits including:
a digital interface receiver circuit which receives a serial data digital image signal and converts the serial data digital image signal to a parallel data digital image signal and regenerates a sync signal and a pixel clock;
a digital interface transmitter circuit which converts the parallel data from the digital interface receiver circuit to a serial data digital image signal and transmits the serial data digital image signal;
a reference signal input terminal which inputs an external reference sync signal;
a selector circuit which selects either one of the sync signal from the digital interface receiver circuit and the external reference sync signal from the reference signal input terminal;
a reference signal output terminal from which the sync signal selected by the selector circuit is output to the outside as a reference sync signal;
a PLL (Phase Locked Loop) which, based on the output signal of the selector circuit, generates a pixel clock in accordance with the resolution of the digital image signal; and
a phase shifter which adjusts the phase of the pixel clock generated by the PLL to the data of the digital image signal regenerated by the digital interface receiver circuit,
wherein the pixel clock which is output from the phase shifter is used as a pixel clock in the digital interface transmitter circuit.

2. The multiscreen display apparatus according to claim 1, wherein the phase shifter is arranged between the PLL and the digital interface transmitter circuit.

3. The multiscreen display apparatus according to claim 1, wherein the phase shifter is inserted between the reference signal input terminal and the selector and adjusts the phase of the external reference sync signal.

4. The multiscreen display apparatus according to claim 2, further comprising a counter which measures the number of horizontal pixels from the pixel clock and horizontal sync signal which are regenerated by the digital interface receiver circuit, wherein
a dividing ratio of the PLL is set based on the data detected by the counter.

5. The multiscreen display apparatus according to claim 1, further comprising:
a signal detection circuit which detects whether a signal input from the reference signal input terminal is present for the external reference sync signal; and
a processor which sets a dividing ratio of the PLL, wherein
if the signal detection circuit judges that no signal input from the reference signal input terminal is present, the processor makes the selector circuit select the sync signal regenerated from the image signal.

6. The multiscreen display apparatus according to claim 1, wherein
the reference signal output terminal of the daisy chain circuit is connected to the reference signal input terminal of the next daisy chain circuit so that the reference sync signal is transmitted concurrently with the image signal.

7. A multiscreen display apparatus comprising a plurality of image display units each having a daisy chain circuit, each of the daisy chain circuit including:
a digital interface receiver circuit which receives a digital image signal;
a digital interface transmitter circuit which transmits the image signal from the digital interface receiver circuit as a digital signal;
a reference signal input terminal which enters the pixel clock of the digital image signal from the outside;
a selector circuit which selects either one of the pixel clock from the digital interface receiver circuit and the pixel clock from the reference signal input terminal;
a reference signal output terminal from which the pixel clock selected by the selector circuit is output to the outside as a reference sync signal; and
a phase shifter which adjusts the phase of the pixel clock selected by the selector circuit to the data of the digital image signal from the digital interface receiver circuit,
wherein the pixel clock which is output from the phase shifter is used as a pixel clock in the digital interface transmitter circuit.

8. The multiscreen display apparatus according to claim 7, comprising:
a signal detection circuit which detects whether a signal from the reference signal input terminal is present for the external reference sync signal, wherein
if the signal detection circuit judges that no signal input from the reference signal input terminal is present, the selector circuit selects the sync signal regenerated from the image signal.

9. A multiscreen display apparatus comprising:
image display units each having a daisy chain circuit according to claim 7, the image display units being daisy-chained, wherein
the reference signal output terminal of the daisy chain circuit is connected to the reference signal input terminal of a subsequent daisy chain circuit so that the reference sync signal is transmitted concurrently with the image signal.

10. The multiscreen display apparatus according to claim 7, wherein
the reference signal output terminal of the daisy chain circuit is connected to the reference signal input terminal of the second or more downstream daisy chain circuit of the daisy chain circuit so that the reference sync signal is transmitted.
